(19) United States
(12) Patent Application Publication
(10) Pub. No.: US 2025/0039345 A1
(43) Pub. Date: Jan. 30, 2025

(54) DISPLAY APPARATUS

(71) Applicant: SONY GROUP CORPORATION, TOKYO (JP)

(72) Inventor: EIJI TORATANI, TOKYO (JP)

(21) Appl. No.: 18/707,233

(22) PCT Filed: Oct. 18, 2022
(86) PCT No.: PCT/JP2022/038796

§ 371 Date: May 3, 2024

(30) Foreign Application Priority Data
Nov. 12, 2021 (JP) 2021-185015

(51) Int. Cl. H04N 9/31; G01J 1/42

(52) U.S. Cl. CPC H04N 9/3182; G01J 1/4204; H04N 9/312; H04N 9/3188; H04N 9/3194; H04N 9/3161

(57) ABSTRACT

A display apparatus according to an embodiment of the present disclosure includes: an image forming unit that generates a projection image on the basis of an inputted picture signal; a detection unit including an illuminance sensor that detects illuminance of ambient light; and a control unit including a plurality of threshold data groups that changes a setting value of pixel information of the projection image in accordance with an installation state and the illuminance detected by the illuminance sensor.

### TECHNICAL FIELD

The present disclosure relates to a display apparatus including, for example, an illuminance sensor.

### BACKGROUND ART

For example, Patent Literature 1 discloses a display control device including: an acquisition unit that acquires environment information around a display unit including a transparent screen that reflects a picture projected from a projector and a light control film having a variable transmittance; and a display control unit that controls pixel information to be projected on the transparent screen and the transmittance of the light control film on the basis of the environment information.

### CITATION LIST

### Patent Literature

Patent Literature 1: Japanese Unexamined Patent Application Publication No. 2020-87049

### SUMMARY OF THE INVENTION

Incidentally, what is desired for a projector is to improve viewability.

It is desirable to provide a display apparatus that makes it possible to improve viewability.

A display apparatus according to one embodiment of the present disclosure includes: an image forming unit that generates a projection image on the basis of an inputted picture signal; a detection unit including an illuminance sensor that detects illuminance of ambient light; and a control unit including a plurality of threshold data groups that changes a setting value of pixel information of the projection image in accordance with an installation state and the illuminance detected by the illuminance sensor.

The display apparatus according to one embodiment of the present disclosure includes the detection unit including the illuminance sensor that detects the illuminance of the ambient light, and the control unit including the plurality of threshold data groups that changes the setting value of the pixel information of the projection image in accordance with the installation state and the illuminance detected by the illuminance sensor. Accordingly, a correction of an image quality corresponding to the ambient light is automatically performed.

### BRIEF DESCRIPTION OF THE DRAWINGS

FIG. 1 is a block diagram illustrating an example of a configuration of a projector according to an embodiment of the present disclosure.

FIG. 2 is a schematic diagram illustrating an external appearance of the projector illustrated in FIG. 1.

FIG. 3 is a diagram illustrating an installation state of the projector illustrated in FIG. 2.

FIG. 4 is a schematic diagram illustrating an example of a configuration of an optical system of the projector illustrated in FIG. 1.

FIG. 5 is a schematic diagram illustrating an example of a configuration of a light source device illustrated in FIG. 1.

FIG. 6 is a diagram illustrating an example of a data table stored in a memory unit illustrated in FIG. 1.

FIG. 7 is a diagram illustrating an example of a threshold data group stored in the memory unit illustrated in FIG. 1.

FIG. 8 is a schematic cross-sectional diagram illustrating an example of an illuminance sensor illustrated in FIG. 1 and a structure around the illuminance sensor.

FIG. 9 is a perspective diagram illustrating an example of a shape of a light guide tube illustrated in FIG. 8.

FIG. 10 is a flowchart illustrating a flow of a control of an image quality of the projector illustrated in FIG. 1.

### MODES FOR CARRYING OUT THE INVENTION

The following describes embodiments of the present disclosure in detail with reference to the drawings. The following description is a specific example of the present disclosure, but the present disclosure is not limited to the following embodiment. In addition, the present disclosure is not limited to arrangement, dimensions, dimensional ratios, and the like of the constituent elements illustrated in the drawings. It is to be noted that the description is given in the following order.
1. Embodiment (an example of a projector having an illuminance sensor and a plurality of threshold data groups that changes an image quality of and a projection image)
2. Other Embodiments

### 1. Embodiment

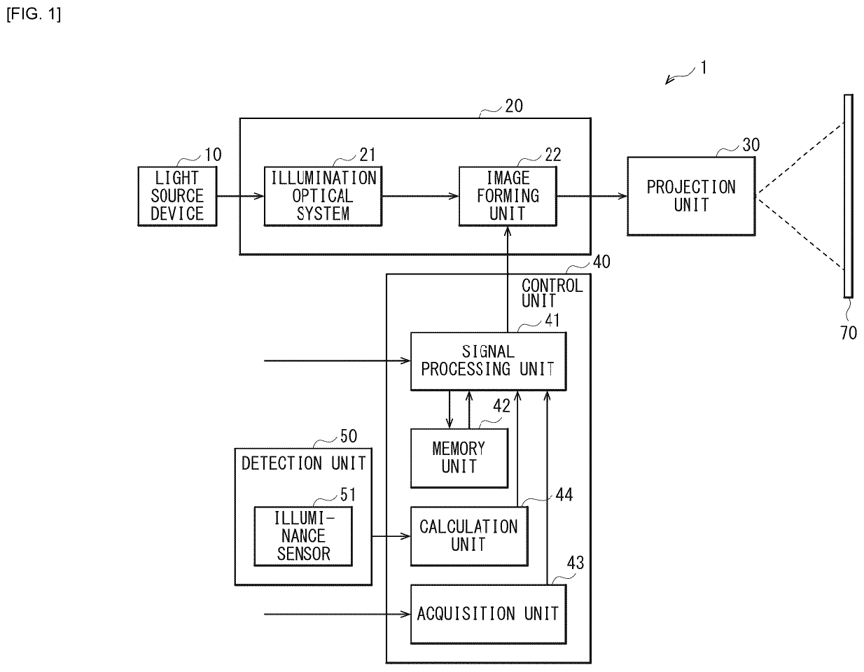

FIG. 1 is a block diagram illustrating an example of a configuration of a display apparatus (a projector 1) according to an embodiment of the present disclosure. The projector 1 enlarges and projects a projection image (projection light) generated by a display device smaller than a size of an image to be projected (the projection image) onto a projection surface such as a wall surface. Here, the “image” includes a still image and a moving image.

### Configuration of Projector

The projector 1 includes, for example, a light source device 10, an image generation system 20, a projection unit 30, a control unit 40, and a detection unit 50. The image generation system 20 includes an illumination optical system 21 and an image forming unit 22. The control unit 40 includes a signal processing unit 41, a memory unit 42, an acquisition unit 43, and a calculation unit 44. The detection unit 50 includes an illuminance sensor 51. The memory unit 42 stores a plurality of threshold data groups that changes pixel information of the projection image in accordance with an installation state of the projector 1 and illuminance detected by the illuminance sensor 51.

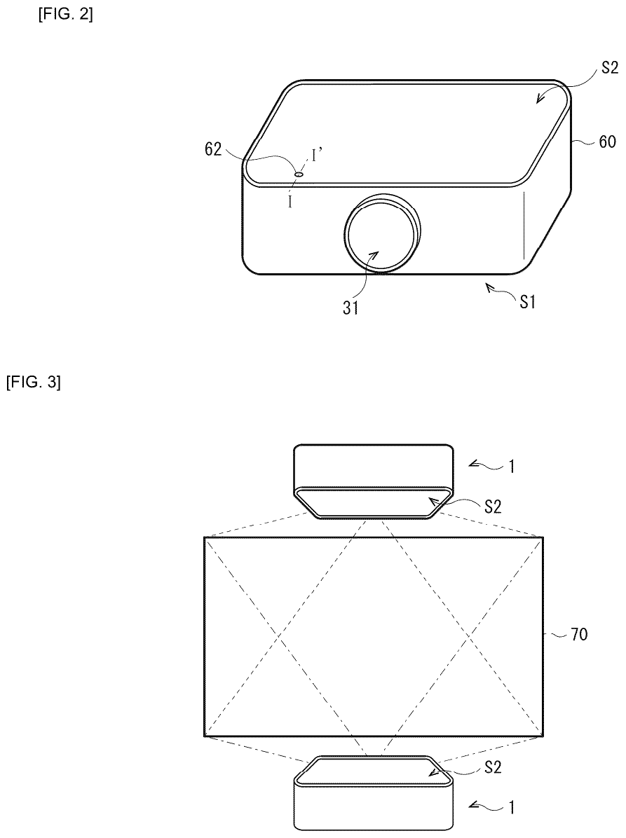

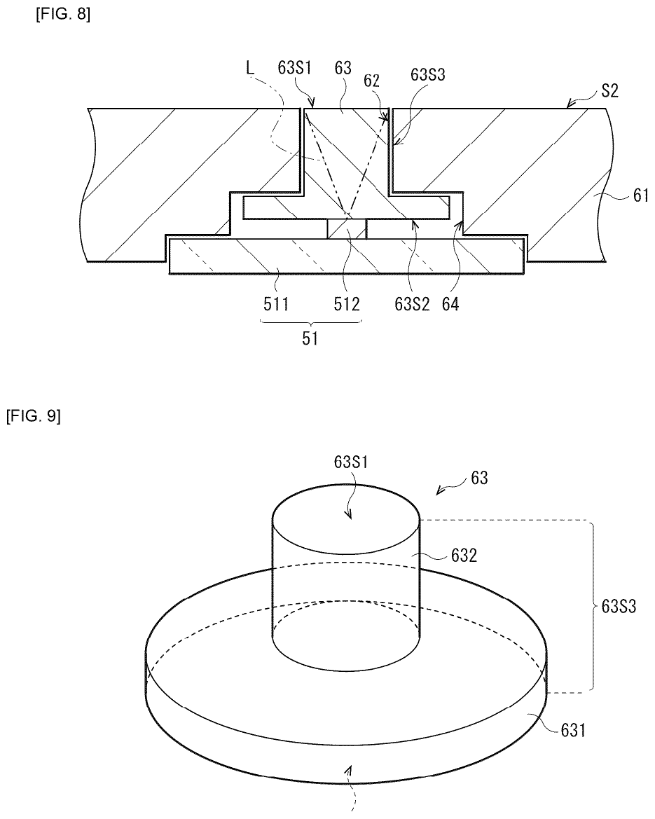

The light source device 10, the image generation system 20, the projection unit 30, the control unit 40, and the detection unit 50 are housed in a housing 60, for example. As illustrated in FIG. 2, for example, the housing 60 has a first surface S1 facing an installation surface on which the projector 1 is installed, and a second surface S2 on an opposite side of the first surface S1. For example, as illustrated in FIG. 8, the illuminance sensor 51 is disposed in the vicinity of the second surface S2.

For example, as illustrated in FIG. 3, the projector 1 is used in a state of being installed on a desk or suspended from a ceiling (a ceiling suspended state). The desktop installation state or the ceiling suspended state corresponds to a specific example of an “installation state” of the present disclosure. The projector 1 automatically corrects the image quality in accordance with ambient light around the projector 1, on the basis of the installation state and the illuminance detected by the illuminance sensor 51.

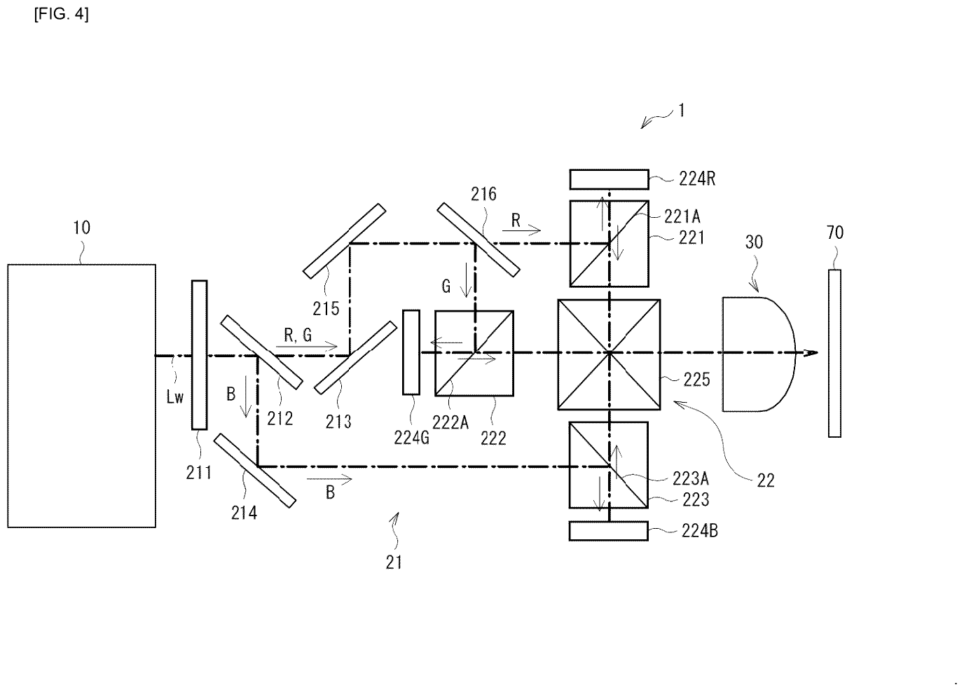

FIG. 4 is a schematic diagram illustrating an example of a configuration of an optical system of a reflective 3LCD type projector that performs optical modulation by a reflective liquid crystal panel (LCD) as an example of a configuration of the projector 1.

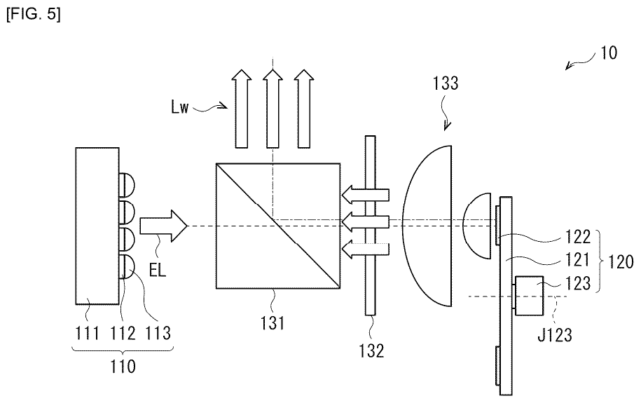

FIG. 5 illustrates an example of a configuration of the light source device 10. The light source device 10 includes, for example, a light source unit 110, a phosphor wheel 120, a polarizing beam splitter (PBS) 131, a quarter-wavelength plate 132, and a condensing optical system 133. The constituent members constituting the light source device 10 are disposed between the light source unit 110 and the phosphor wheel 120 in the order of the PBS 131, the quarter-wavelength plate 132, and the condensing optical system 133 from the light source unit 110 in an optical path of light (excitation light EL) outputted from the light source unit 110.

The light source unit 110 includes, for example, a plurality of solid-state light emitting devices 112 that outputs light of a predetermined wavelength band (the excitation light EL) as a light source. The plurality of solid-state light emitting devices 112 are arranged, for example, in an array on a base portion 111.

The base portion 111 supports the plurality of solid-state light emitting devices 112 and promotes heat dissipation of the plurality of solid-state light emitting devices 112 generated by light emission. Therefore, the base portion 111 preferably includes a material having a high thermal conductivity, and includes, for example, aluminum (Al), copper (Cu), iron (Fe), or the like.

For example, a semiconductor laser (Laser Diode: LD) is used for the plurality of solid-state light emitting devices 112. Specifically, for example, an LD that oscillates laser light (blue light) in a wavelength band corresponding to a blue color of a wavelength from 400 nm to 470 nm is used. Besides, a light-emitting diode (Light Emitting Diode: LED) may be used as the plurality of solid-state light emitting devices 112.

Above the plurality of solid-state light emitting devices 112, a plurality of lenses 113 is respectively disposed for the solid-state light emitting devices 112. The plurality of lenses 113 is, for example, a collimating lens, and adjusts and outputs the laser light (the excitation light EL) outputted from each of the plurality of solid-state light emitting devices 112 to collimated light.

The phosphor wheel 120 is a wavelength converting device that converts the excitation light EL into light (fluorescent FL) having a wavelength band differing from that of the excitation light EL and outputs the light. The phosphor wheel 120 is provided with a phosphor layer 122 on a wheel substrate 121 that is rotatable about a rotational axis (for example, an axis J123).

The wheel substrate 121 is adapted to support the phosphor layer 122, and has, for example, a disk shape. The wheel substrate 121 preferably further has a function as a heat dissipation member. Therefore, the wheel substrate 121 may be formed by a metal material having high thermal conductivity. In addition, the wheel substrate 121 may be formed using a metal material or a ceramic material that allows for mirror finishing. As a result, it is possible to suppress an increase in temperature of the phosphor layer 122 and to improve an extraction efficiency of the fluorescent FL.

The phosphor layer 122 includes a plurality of phosphor particles, and is excited by the excitation light EL to emit light (the fluorescent FL) in a wavelength band different from the wavelength band of the excitation light EL. Specifically, the phosphor layer 122 includes phosphor particles that are excited by the blue light (the excitation light EL) outputted from the light source unit 110 and emit the fluorescent FL in a wavelength band corresponding to yellow. Such phosphor particles include, for example, a YAG (yttrium-aluminum-garnet) based material. The phosphor layer 122 may further include semiconductor nanoparticles such as quantum dots, organic dyes, or the like. The phosphor layer 122 is formed in, for example, a plate shape, and is configured by, for example, a so-called ceramic phosphor or a binder-type phosphor. The phosphor layer 122 is continuously formed on the wheel substrate 121, for example, in a rotational circumferential direction.

For example, a motor 123 is attached to the center of the wheel substrate 121. The motor 123 is adapted to rotationally drive the wheel substrate 121 at a predetermined rotational speed. As a result, the phosphor wheel 120 is rotatable, and a position of the phosphor layer 122 irradiated with the excitation light EL is temporally changed (moved) at a speed corresponding to the rotational speed. This makes it possible to avoid a deterioration of the phosphor particles caused by long-time irradiation with the excitation light at the same position of the phosphor layer 122.

The PBS 131 separates the excitation light EL incident from the light source unit 110 and the multiplexed light (e.g., white light Lw) incident from the phosphor wheel 120. Specifically, the PBS 131 outputs the excitation light EL incident from the light source unit 110 toward the quarter-wavelength plate 132. Further, the PBS 131 reflects the white light Lw transmitted from the phosphor wheel 120 through the condensing optical system 133 and the quarter-wavelength plate 132 and incident thereon toward the illumination optical system 21.

The quarter-wavelength plate 132 is a retardation element that generates a phase difference of π/2 with respect to incident light, converts linearly polarized light into circularly polarized light when the incident light is linearly polarized light, and converts circularly polarized light into linearly polarized light when the incident light is circularly polarized light. The excitation light EL of the linearly polarized light entering from the PBS 131 is converted into the excitation light EL of the circularly polarized light by the quarter-wavelength plate 132. Further, excitation light components of the circularly polarized light included in the white light Lw entering from the phosphor wheel 120 are converted into the linearly polarized light by the quarter-wavelength plate 132.

The condensing optical system 133 condenses the excitation light EL incident from the quarter-wavelength plate 132 to a predetermined spot size and outputs the condensed excitation light EL toward the phosphor wheel 120. The condensing optical system 133 converts the white light Lw incident from the phosphor wheel 120 into collimated light and outputs the collimated light toward the quarter-wavelength plate 132. Note that the condensing optical system 133 may be configured by, for example, one collimating lens, or may be configured by converting the incident light into parallel light by using a plurality of lenses.

A configuration of an optical member that separates the excitation light EL incident from the light source unit 110 and the white light Lw incident from the phosphor wheel 120 is not limited to the PBS 131, and any optical member may be used as long as the configuration allows for the light separation operation described above. Further, the light source device 10 does not have to include all of the optical members illustrated in FIG. 5, and may include any other optical member. For example, the light source device 10 may include a plurality of phosphor wheels.

The illumination optical system 21 includes a PS converter 211, dichroic mirrors 212 and 216, and total reflection mirrors 213, 214, and 215 along an optical axis of the white light Lw outputted from the light source device 10. The image forming unit 22 includes PBSs 221, 222, and 223, reflective liquid crystal panels 224R, 224G, and 224B, and a cross prism 225 as a color combiner. The projection unit 30 projects combined light outputted from the cross prism 225 toward the screen 70.

The PS converter 211 functions to polarize and transmit the white light Lw incident from the light source device 10. Here, S-polarized light is transmitted as it is, and P-polarized light is converted into the S-polarized light.

The dichroic mirror 212 has a function of separating the white light Lw transmitted through the PS converter 211 into the blue light B and other pieces of color light (red light R and green light G). The total reflection mirror 213 reflects the pieces of color light (the red light R and the green light G) transmitted through the dichroic mirror 212 toward the total reflection mirror 215, and the total reflection mirror 215 reflects the reflected light (the red light R and the green light G) from the total reflection mirror 213 toward the dichroic mirror 216. The dichroic mirror 216 has a function of separating the pieces of color light (the red light R and the green light G) incident from the total reflection mirror 215 into the red light R and the green light G. The total reflection mirror 214 reflects the blue light B separated by the dichroic mirror 212 toward the PBS 223.

The PBSs 221, 222, and 223 are disposed along the respective optical paths of the red light R, the green light G, and the blue light B. The PBSs 221, 222, and 223 respectively have polarization separation planes 221A, 222A, and 223A, and have a function of separating the pieces of incident color light into two polarization components orthogonal to each other in the polarization separation planes 221A, 222A, and 223A. The polarization separation planes 221A, 222A, and 223A reflect one polarization component (e.g., an S-polarization component) and transmits the other polarization component (e.g., a P-polarization component).

The pieces of color light (e.g., the red light R, the green light G, and the blue light B) of a predetermined polarization component (e.g., S-polarization component) separated at the polarization separation planes 221A, 222A, and 223A enter the respective reflective liquid crystal panels 224R, 224G, and 224B. The reflective liquid crystal panels 224R, 224G, and 224B are driven in accordance with a drive voltage given on the basis of a picture signal, modulate the respective pieces of incident light, and reflect the respective pieces of modulated color light (the red light R, the green light G, and the blue light B) toward the PBSs 221, 222, and 223.

The cross prism 225 combines the pieces of color light (the red light R, the green light G, and the blue light B) of a predetermined polarization component (for example, P-polarization component) outputted from the reflective liquid crystal panels 224R, 224G, and 224B and transmitted through the PBSs 221, 222, and 223, and outputs the combined pieces of color light toward the projection unit 30.

The projection unit 30 includes, for example, a plurality of lenses (for example, the lens 31; see FIG. 2) and the like, and enlarges the projection image (the projection light) created by the image forming unit 22 and projects the projection image onto the screen 70.

As described above, the control unit 40 includes the signal processing unit 41, the memory unit 42, the acquisition unit 43, and the calculation unit 44. The control unit 40 further includes, for example, a CPU (Central Processing Unit), a ROM (Read Only Memory), and a RAM (Random Access Memory (all of which are not illustrated). The CPU reads a control program stored in the ROM, expands the control program in the RAM, and executes steps of the program on the RAM. The control unit 40 controls the entire operation of the projector 1 by executing the program on the basis of the CPU.

For example, the control unit 40 so controls the pixel information of the projection image that the projection image to be projected from the projector 1 onto the screen 70 has an appropriate image quality corresponding to the ambient light around the projector 1. Specifically, the control unit 40 so controls an output value of the picture signal that the contrast, the resolution, the color development, and the like of the projection image to be projected onto the screen 70 has setting values corresponding to the illuminance, in accordance with the illuminance detected by the illuminance sensor 51.

For example, in a case where it is determined that the surroundings of the projector 1 are dark (e.g., in a state suitable for use of the projector 1 such as a dark room), the control unit 40 supplies a standard picture signal to a driving unit (not illustrated) of the image forming unit 22. In addition, for example, in a case where it is determined that the surroundings of the projector 1 are light (for example, the projector 1 is exposed to external light (white light) or the like), the control unit 40 supplies, to the driving unit of the image forming unit 22, a picture signal in which the contour and color of a picture become clearer.

The signal processing unit 41 performs various types of signal processing on a picture signal inputted from an external device such as a computer, a DVD player, or a TV tuner. The signal processing unit 41 performs resizing, gamma adjustment, color adjustment, and the like of an image by, for example, characteristic correction, amplify, or the like of the picture signal, and decomposes the picture signal into respective pieces of image data of R, G, and B. In addition, the signal processing unit 41 generates a light modulation signal adapted to drive the reflective liquid crystal panels 224R, 224G, and 224B for the respective pieces of color light, and supplies the light modulation signal to the driver of the image forming unit 22.

For example, a signal (a display direction designation signal) for a user to designate a display direction of the projection image is inputted to the signal processing unit 41 from the acquisition unit 43. Specifically, as illustrated in FIG. 3, for example, a signal that designates a normal image is inputted in a case of the desktop installation state where the second surface S2 of the housing 60 is an upper surface. Further, as illustrated in FIG. 3, for example, in a case of the ceiling-suspended state where the second surface S2 of the housing 60 is a lower surface, a signal that designates an inverted image (a reversed image) in which the upper, lower, left, and right sides of the image is inverted is inputted.

Furthermore, the environment information based on the ambient light around the projector 1 is inputted to the signal processing unit 41 from the calculation unit 44. Specifically, for example, illuminance information including an average illuminance value measured at predetermined intervals by the illuminance sensor 51 and calculated by the calculation unit 44 and a change direction of the illuminance from the previous average illuminance value is inputted at predetermined intervals, for example.

The signal processing unit 41 generates the picture signal corresponding to the ambient light around the projector 1 on the basis of the inputted display direction designation signal and the illuminance information, and supplies the picture signal to the driving unit of the image forming unit 22. Specifically, for example, on the basis of the inputted display direction designation signal and environment information, the signal processing unit 41 refers to a data table and a corresponding threshold data group stored in the memory unit 42, which will be described later, generates the picture signal in which the pixel information such as contrast, resolution, or color development is corrected, and supplies the picture signal to the driving unit of the image forming unit 22.

Note that it is possible to improve the projection image deteriorated by external light (white light) in viewability by raising each image quality component such as contrast, a sense of resolution, or color development in a positive (+) direction. For example, it is possible to increase the contrast by increasing the brightness by raising an intermediate signal level in the positive (+) direction. Alternatively, it is possible to make a low-gradation portion easier to see by raising the brightness of the entire projection image in the positive (+) direction. It is possible to improve the sense of resolution by, for example, emphasizing edges by super-resolution. In addition, color raising by the color makes it possible to improve the color development and the contrast.

The memory unit 42 stores data in which information on how to control the pixel information of the projection image is set in accordance with the installation state of the projector 1 and the ambient illuminance.

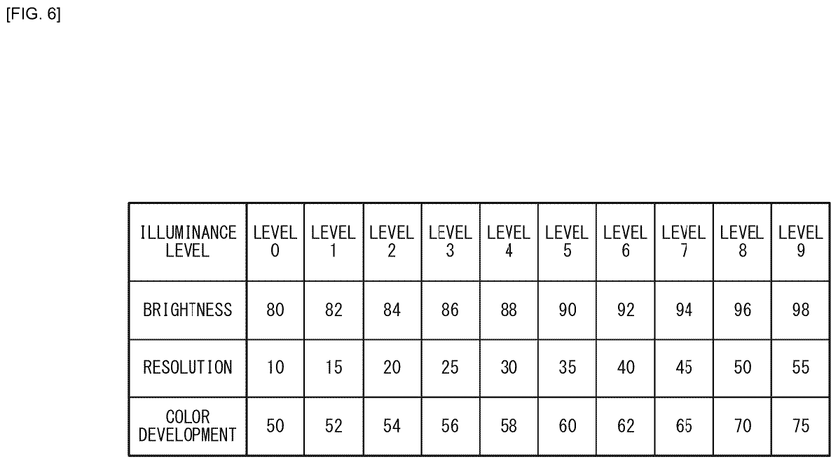

FIG. 6 is an example of a data table stored in the memory unit 42. The data table includes setting information in which the illuminance around the projector 1 and the pixel information of the projection image are respectively associated with each other, and includes items including, for example, “illuminance level”, “brightness”, “resolution”, and “color development”. As the illuminance level, for example, a dark room environment suitable for use of the projector 1 is set to level 0, and values of “brightness”, “resolution”, and “color development” of, for example, 10 levels from level 0 to level 9 are set.

The memory unit 42 further stores the plurality of threshold data groups corresponding to the installation state of the projector 1. For example, the memory unit 42 has the threshold data groups that are different depending on whether the projector 1 is in the desktop installation state (A) or the ceiling-suspended state (B).

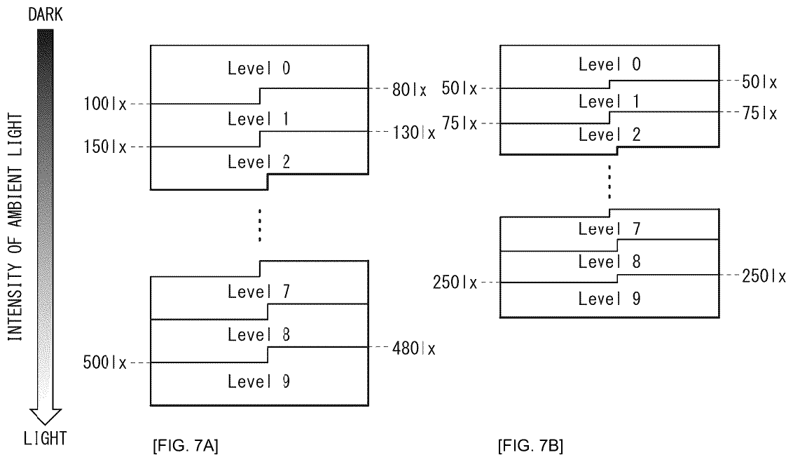

(A) of FIG. 7 is an example of the threshold data group when a reference destination (the illuminance level of the data table) of the setting information referred to by the signal processing unit 41 is switched in the desktop installation state, for example. (B) of FIG. 7 is an example of the threshold data group when the reference destination (the illuminance level of the data table) of the setting information referred to by the signal processing unit 41 is switched in the ceiling-suspended state, for example.

The threshold data groups illustrated in (A) and (B) of FIG. 7 each have hysteresis characteristics in which thresholds at the time of switching the illuminance level of the data table to be referred to in the change direction of the illuminance around the projector 1 are different from each other. For example, the threshold in a case where the illuminance around the projector 1 changes in an increasing direction is set higher than the threshold when the illuminance around the projector 1 changes in the decreasing direction. Specifically, for example, where a threshold that is switched from level 0 to level 1 by an increase in the illuminance around the projector 1 is 100 lx, a threshold that is switched from level 1 to level 0 by a decrease in the illuminance around the projector 1 is set to 80 lx. This reduces frequent switching of image quality due to changes in the illuminance around the projector 1.

For example, the acquisition unit 43 acquires the installation information of the projector 1 from the display direction of the projection image selected by the user, generates the display direction designation signal, and supplies the display direction designation signal to the signal processing unit 41.

For example, the calculation unit 44 acquires the environment information around the projector 1 detected by the detection unit 50, and supplies the acquired environment information around the projector 1 to the signal processing unit 41. For example, the calculation unit 44 calculates the average illuminance value from the N-number of times of illuminance sensor values measured at predetermined intervals by the illuminance sensor 51, and supplies the calculated average illuminance value to the signal processing unit 41 as the illuminance information. Further, from the second time onward, the calculation unit 44 supplies, together with the average illuminance value, the change direction from the previous average illuminance value as the illuminance information to the signal processing unit 41.

The detection unit 50 detects various types of information by controlling various types of sensors.

For example, the detection unit 50 includes the illuminance sensor 51, and detects the illuminance around the projector 1 by controlling the illuminance sensor 51. The detection unit 50 supplies illuminance value (the illuminance sensor value) obtained by the illuminance sensor 51 to the calculation unit 44.

The illuminance sensor 51 is a device that is also referred to as an ambient light sensor or the like, and detects the ambient illuminance using a phototransistor, a photodiode, or the like.

FIG. 8 schematically illustrates an exemplary cross-sectional configuration of the illuminance sensor 51 corresponding to I-I′ line illustrated in FIG. 2 and its surroundings.

The illuminance sensor 51 includes, for example, a substrate 511 and a light receiving element 512. The light receiving element 512 is configured by, for example, a phototransistor. As illustrated in FIG. 8, the illuminance sensor 51 is disposed, for example, in the vicinity of the second surface S2 of the housing 60.

For example, the housing 60 is provided with an intake window 62 adapted to take in the ambient light L in the top cover 61 configuring the second surface S2. For example, a digging portion 64 into which the illuminance sensor 51 is fitted is provided around the intake window 62 on the back side of the top cover 61.

The illuminance sensor 51 is so disposed in the digging portion 64 that the light receiving element 512 is disposed below the intake window 62. A light guide tube 63 is fitted in the intake window 62, and the ambient light L taken in from the intake window 62 is guided to the light receiving element 512.

FIG. 9 schematically illustrates an example of a shape of the light guide tube 63 illustrated in FIG. 8.

The light guide tube 63 has a light intake surface 63S1 that forms substantially the same surface as the second surface S2 of the housing 60, and a light extraction surface 63S2 that faces the light intake surface 63S1. The light guide tube 63 has, for example, a base portion 631 facing a bottom surface of the digging portion 64, and a convex portion 632 fitted into the intake window 62. An upper surface of the convex portion 632 corresponds to the light intake surface 63S1, and a lower surface of the base portion 631 on an opposite side of a surface facing the bottom surface of the digging portion 64 corresponds to the light extraction surface 63S2. A surface of the light guide tube 63 is embossed, thereby reducing an incident angle dependency of light.

The light guide tube 63 includes a transparent material having light transmittance. Examples of the transparent material include acrylic resin, polycarbonate, glass, polystyrene, and urethane. For example, a plurality of scattering particles is kneaded in the transparent material, thereby further reducing the incident angle dependency of light.

Examples of the scattering particles include silicon oxide (SiO₂), titanium oxide (TiO₂), aluminum oxide (Al₂O₃), aluminum nitride (AlN), boron nitride (BN), and zinc oxide (ZnO). The scattering particles may be, for example, bubbles mixed in the transparent material.

The light guide tube 63 may further paint a side surface 63S3 between the light intake surface 63S1 and the light intake surface 63S1 in a single color. For example, the side surface 63S3 of the light guide tube 63 may be black-painted or white-painted using a paint or the like. In the light guide tube 63 illustrated in FIG. 9, a surface, of the base portion 611, facing the bottom surface of the digging portion 64, a side surface of the base portion 631, and a side surface of the convex portion 632 correspond to a “side surface” of the light guide tube 63.

Alternatively, an inner side of the intake window 62 and the digging portion 64 of the housing 60 in which the light guide tube 63 is fitted may be shielded from light. Specifically, the inner side of the intake window 62 and the digging portion 64 of the housing 60 in which the light guide tube 63 is fitted may be painted with a single color such as black paint or white paint.

As a result, variations in the illuminance sensor value caused by the transmitted light and the reflected light from the second surface S2 of the housing 60 are reduced. In addition, an influence of a color of the housing 60 is reduced.

### Control Method of Projector

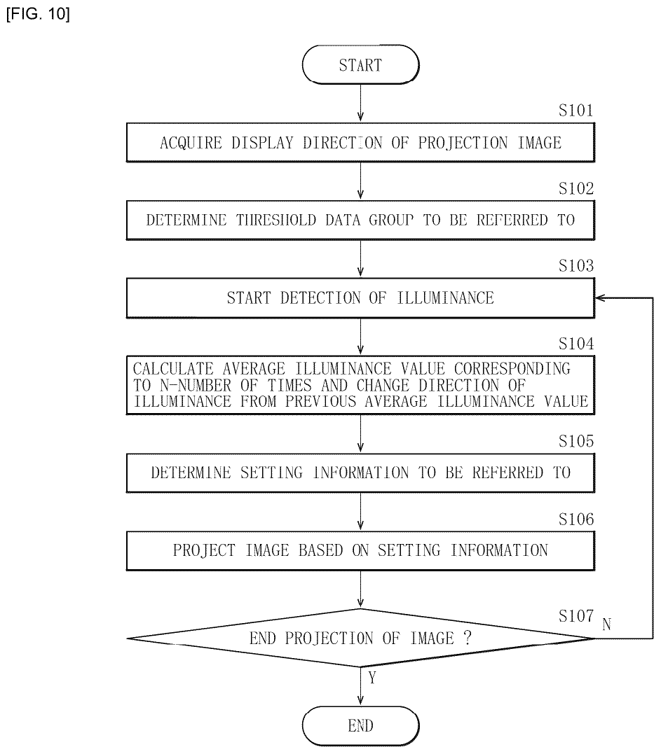

A control of the image quality during the projection of the projector 1 will be described with reference to a flowchart illustrated in FIG. 10.

Upon starting the control of the image quality of the projection image, first, the acquisition unit 43 confirms the display direction of the projection image selected by the user and acquires the information thereof (step S101).

Next, the signal processing unit 41 determines the threshold data group to be referred to from the display direction designation signal supplied from the acquisition unit 43 (step S102).

Subsequently, the detection unit 50 starts detecting the illuminance around the projector 1 (step S103). Here, the illuminance sensor 51 measures the illuminance around the projector 1 N-number of times at predetermined time intervals.

Next, the calculation unit 44 calculates the average illuminance value from the N-number of times of illuminance sensor values measured by the illuminance sensor 51. In addition, the calculation unit 44 calculates the change direction of the illuminance from the previous average illuminance value (step S104).

Subsequently, the signal processing unit 41 determines the setting information of the data table to be referred to, on the basis of the illuminance information calculated by the calculation unit 44 (step S105). Next, the signal processing unit 41 generates the picture signal that becomes the pixel information corresponding to the setting information of the data table to be referred to, and supplies the picture signal to the driving unit of the image forming unit 22. Thus, the projector 1 projects the projection image corresponding to the illuminance around the projector 1 onto the screen 70 (step S106).

Thereafter, the projector 1 determines whether an operation of ending the projection of the projection image has been received from the user (step S107). If the operation of ending the projection of the projection image is not received from the user (step S107: N), the projector 1 repeats the step S103 to step S107, and continues to so adjust the brightness, resolution, and color development of the projection image as to obtain an appropriate image quality corresponding to the illuminance around the projector 1. If the operation of ending the projection of the image is received from the user (step S107: Y), the projector l ends the projection of the projection image.

### Workings and Effects

The projector 1 of the present embodiment includes the detection unit 50 including the illuminance sensor 51 that detects the illuminance of the ambient light, and the control unit 40 including the plurality of threshold data groups that changes the setting value of the pixel information of the projection image in accordance with the installation state and the illuminance detected by the illuminance sensor 51, so as to automatically correct the image quality in accordance with the ambient light. This will be described below.

As described above, the projector 1 according to the present embodiment makes it possible to improve the quality of the projection image.

### 2. Other Embodiments

In the above-described embodiment, an example has been described in which the installation state of the projector 1 is determined from the display direction of the projection image designated by the user, but it is not limited thereto. For example, an acceleration sensor may be mounted on the detection unit 50 so as to detect the installation state of the projector 1.

Further, in the above embodiment, an example has been described in which the plurality of threshold data groups set in advance are stored in the memory unit 42, but the plurality of thresholds configuring the threshold data groups may be obtained from a calculation formula.

Further, in the above embodiment, an example has been described in which the projector 1 and the display unit (screen 70) are spatially separated from each other, but the projector 1 and the display unit may be integrated with each other. For example, the projector 1 may be embedded in a bezel (edge) at a lower portion or an upper portion of the display unit.

Although the present technology has been described with reference to the embodiments and other embodiments, the present technology is not limited to the above-described embodiments and the like, and various modifications are possible.

For example, in the above-described embodiment and the like, the optical members constituting the projector 1 have been specifically described, but it is not necessary to include all the optical members, and any other optical member may be further provided.

It is to be noted that the effects described in the present specification are merely examples, but not limited. Moreover, other effects may be included.

Note that it is possible for the present disclosure to include the following configurations. According to the present technology having the following configuration, the detection unit including the illuminance sensor that detects the illuminance of the ambient light and the control unit including the plurality of threshold data groups that changes the image quality of the projection image in accordance with the installation state and the illuminance detected by the illuminance sensor are provided. Thus, the correction of the image quality corresponding to the ambient light is automatically performed. Therefore, it is possible to improve the viewability.
(1)

A display apparatus including:
an image forming unit that generates a projection image on a basis of an inputted picture signal;
a detection unit including an illuminance sensor that detects illuminance of ambient light; and
a control unit including a plurality of threshold data groups that changes pixel information of the projection image in accordance with an installation state and the illuminance detected by the illuminance sensor.
(2)

The display apparatus according to (1), in which
the control unit further includes setting information in which the illuminance and the pixel information are associated with each other,
the plurality of threshold data groups each includes a plurality of thresholds that switches the setting information to be referred to in accordance with the illuminance, and
the plurality of thresholds are different from each other in an increasing direction and a decreasing direction of the illuminance.
(3)

The display apparatus according to (1) or (2), further including a housing having a first surface facing an installation surface and a second surface on an opposite side of the first surface, and housing the image forming unit, the detection unit, and the control unit.
(4)

The display apparatus according to (3), in which the control unit includes, as the plurality of threshold data groups, a first threshold data group selected in a case where the second surface is an upper surface, and a second threshold data group selected in a case where the second surface is a lower surface.
(5)

The display apparatus according to (3) or (4), in which
the housing has an intake window that takes the ambient light into the second surface, and
the illuminance sensor is disposed adjacent to the second surface.
(6)

The display apparatus according to (5), in which a light guide tube that guides the ambient light to the illuminance sensor is fitted in the intake window.
(7)

The display apparatus according to (6), in which a surface of the light guide tube is embossed.
(8)

The display apparatus according to (6) or (7), in which a plurality of scattering particles is mixed in the light guide tube.
(9)

The display apparatus according to any one of (6) to (8), in which
the light guide tube has a light intake surface that forms substantially a same surface as the second surface of the housing, a light extraction surface that faces the light intake surface and takes out the taken-in ambient light to the illuminance sensor, and a side surface provided between the light intake surface and the light extraction surface, and
the side surface of the light guide tube is painted in a single color.
(10)

The display apparatus according to any one of (6) to (9), in which a surface, of the housing, facing the light guide tube and the illuminance sensor is shielded from light.
(11)

The display apparatus according to any one of (1) to (10), further including a projection unit that projects the projection image generated by the image forming unit.

The present application claims the benefit of Japanese Priority Patent Application JP2021-185015 filed with the Japan Patent Office on Nov. 12, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A display apparatus comprising:
an image forming unit that generates a projection image on a basis of an inputted picture signal;
a detection unit including an illuminance sensor that detects illuminance of ambient light; and
a control unit including a plurality of threshold data groups that changes pixel information of the projection image in accordance with an installation state and the illuminance detected by the illuminance sensor.

2. The display apparatus according to claim 1, wherein
the control unit further includes setting information in which the illuminance and the pixel information are associated with each other,
the plurality of threshold data groups each includes a plurality of thresholds that switches the setting information to be referred to in accordance with the illuminance, and
the plurality of thresholds are different from each other in an increasing direction and a decreasing direction of the illuminance.

3. The display apparatus according to claim 1, further comprising a housing having a first surface facing an installation surface and a second surface on an opposite side of the first surface, and housing the image forming unit, the detection unit, and the control unit.

4. The display apparatus according to claim 3, wherein the control unit includes, as the plurality of threshold data groups, a first threshold data group selected in a case where the second surface is an upper surface, and a second threshold data group selected in a case where the second surface is a lower surface.

5. The display apparatus according to claim 3, wherein
the housing has an intake window that takes the ambient light into the second surface, and
the illuminance sensor is disposed adjacent to the second surface.

6. The display apparatus according to claim 5, wherein a light guide tube that guides the ambient light to the illuminance sensor is fitted in the intake window.

7. The display apparatus according to claim 6, wherein a surface of the light guide tube is embossed.

8. The display apparatus according to claim 6, wherein a plurality of scattering particles is mixed in the light guide tube.

9. The display apparatus according to claim 6, wherein
the light guide tube has a light intake surface that forms substantially a same surface as the second surface of the housing, a light extraction surface that faces the light intake surface and takes out the taken-in ambient light to the illuminance sensor, and a side surface provided between the light intake surface and the light extraction surface, and
the side surface of the light guide tube is painted in a single color.

10. The display apparatus according to claim 6, wherein a surface, of the housing, facing the light guide tube and the illuminance sensor is shielded from light.

11. The display apparatus according to claim 1, further comprising a projection unit that projects the projection image generated by the image forming unit.
